(19) United States
(12) Patent Application Publication
(10) Pub. No.: US 2002/0040372 A1
(43) Pub. Date: Apr. 4, 2002

(54) Sticker distribution system and method

(76) Inventor: Kazuhiro Ide, Kanagawa-ken (JP)

Correspondence Address: SLATER & MATSIL, L.L.P., 17950 PRESTON RD, SUITE 1000, DALLAS, TX, 75252-5793, US

(21) Appl. No.: 09/923,251

(22) Filed: Aug. 3, 2001

(30) Foreign Application Priority Data
Oct. 4, 2000 (JP) 2000-305391

(51) Int. Cl. G06F 17/00

(52) U.S. Cl. 707/513; 707/514

(57) ABSTRACT

A sticker distribution system and method enabling the state of attachment of a sticker to be visualized by a browser and enabling a sufficient advertising effect. A prize information display unit of a server displays a first page carrying the names of sponsors, conditions for display of stickers, and prizes on the browsers of terminals connected to the Internet. When a sponsor is specified, a sticker information display unit displays a second page on the browsers of the terminals. When the sticker sample, car type, and car color have been selected at the second page, an image extraction unit displays an image of the rear of a car of the selected type and selected color to which the selected sticker sample was attached. The user can register user information through the ID page to the user registration unit. The user preference information transmitting unit issues the sticker sample selected by the user and preference information on the product to the sponsor through a question page. Preferably, a display confirmation device is installed in a gasoline station to confirm that the sticker is actually attached.

### BACKGROUND OF THE INVENTION

1. Field of the Invention

The present invention relates to a sticker distribution system which distributes stickers of sponsors to car owners for display.

2. Description of the Related Art

In the past, one method to get a sponsor's logo etc. displayed on cars to advertise the products of the sponsor has been to get the car owners to attach stickers to the sides of their cars in return for cash incentives. Specifically, intermediaries solicited prospective sticker displayers over the Internet and received fees in accordance with the number solicited from the sponsors. They then paid part of the fees to the prospective sticker displayers to get them to attach the stickers to the sides of their cars when driving.

A second advertising method has been to get car owners to attach large seals displaying the sponsor's logo etc. to the entire surfaces of their cars in return for certain cash incentives.

There were however the following problems to be solved, which problems are solved by preferred embodiments of the invention:

First, with the first method, a prospective sticker displayer could not check how the sticker would look when attached to his or her car on the browser, so sometimes the prospective displayer found it looked far different from imagined when actually attached. Further, since the sticker is attached to the side of the car, it is mainly visible to pedestrians. Pedestrians, however, seldom take the time to look closely at the sides of passing cars, so the effect of the sticker was small. Further, car drivers and passengers watch the cars in front of them rather than the cars running alongside them and seldom take the time to look closely at the stickers of the cars next to them. Further, the sponsor finds it difficult to confirm that prospective sticker displayers scattered across a broad region have actually attached the stickers to their cars.

Next, with the above second method, since the seal displaying the fancy logo etc. is attached to the entire surface of the car, pedestrians and drivers or passengers of other cars will often look at it closely. Few people however are willing to attach seals to the entire surfaces of their cars. Most ordinary people often would never attach such seals to their cars. Therefore, there are very few cars displaying such seals and a sufficient advertising effect cannot be obtained.

### SUMMARY OF THE INVENTION

An object of the present invention is to provide a sticker distribution system and method which enables the state of a sticker attached to a car to be visualized on a browser and gives a sufficient advertising effect.

To achieve the above object, according to a first aspect of the present invention, there is provided a sticker distribution system comprising a prize information display unit for displaying, on a browser of a terminal connected to the Internet, a first page carrying the names of sponsors of products, conditions for displaying stickers, and prize information showing prizes; a sticker information display unit for displaying, on a browser of a terminal, a second page linked with prize information of a sponsor designated at a terminal, having a sticker sample window, a car type window, and a car color window, and displaying the rear image of a car with a sample of a predetermined sticker attached; an image extraction unit for reading from a database storing a plurality of car rear images showing samples of stickers attached to the rears of various types of cars of various colors, a car rear image comprising the sample of a sticker selected in the sticker sample window, the type of the car selected in the car type window, and the color of the car selected in the car color window on the display unit; a user registration unit for registering user information; and a user preference information transmitting unit for transmitting to the sponsor the sticker sample selected by the user of a terminal and user preference information regarding a product of a sponsor providing the sticker sample.

In this configuration, the prize information display unit displays a first page carrying names of sponsors of products, the conditions for display of stickers, and prize information showing prizes on the browser of a terminal connected to the Internet. When the prize information is selected, the sticker information display unit displays a second page including a sticker sample window, a car type window, a car color window, and a rear view of the car with a predetermined sticker sample attached on the browser of the terminal. After a sticker sample is selected at the sticker sample window, a car type is selected at the car type window, and a car color is selected at the car color window, the image extraction unit reads out a rear image of the car comprised of the rear image of the car of the selected type and selected color with the selected sticker attached from the database of the display unit. It is also possible to register user information identifying the user in the user registration unit. The sticker sample selected by the user of the terminal and user preference information regarding the products of the sponsor providing the sticker sample are transmitted to the sponsor by the user preference information transmitting unit.

Preferably, the system further provides identification information on a sticker in accordance with the selected sticker sample and provides different points in a predetermined region with display confirmation devices for identifying the identification information of the sticker and sending the identification information to the sponsor providing the sticker through a predetermined communications line.

The method of working the system of the first aspect of the invention and its preferred embodiment also stands as a method invention. According to a second aspect of the present invention, therefore, there is provided a sticker distribution method comprising the steps of displaying, on a browser of a terminal connected to the Internet, a first page carrying the names of sponsors of products, conditions for displaying stickers, and prize information showing prizes; displaying, on a browser of a terminal, a second page linked with prize information of a sponsor designated at a terminal, having a sticker sample window, a car type window, and a car color window, and displaying the rear image of a car in the state with a sample of a predetermined sticker attached; extracting a car rear image comprising a rear image of a car of a selected type of and selected color to which a selected sticker sample has been attached based on the sticker sample selected in the sticker sample window, the type of the car selected in the car type window, and the color of the car selected in the car color window and displaying it on the display unit; registering user information identifying the user of a terminal; transmitting the sticker sample selected by the user of the terminal and user preference information regarding the products of the sponsor providing the sticker sample to the sponsor; providing identification information on a sticker in accordance with the selected sticker sample; and identifying the identification information of the sticker at different points in a predetermined region and sending the identification information to the sponsor providing the sticker through a predetermined communications line.

### BRIEF DESCRIPTION OF THE DRAWINGS

These and other objects and features of the present invention will be more apparent from the following description given with reference to the accompanying drawings, wherein:

FIG. 1 is a block diagram of a sticker distribution system according to an embodiment of the present invention;

FIG. 2 is a schematic view of a linked state of pages;

FIG. 3 is a plan view of a product category page;

FIG. 4 is a plan view of a first page;

FIG. 5 is a plan view of a second page;

FIG. 6 is a plan view of an ID page;

FIG. 7 is a plan view of a question page; and

FIG. 8 is the view of the appearance of a sticker provided with identification information.

### DESCRIPTION OF THE PREFERRED EMBODIMENTS

Next, an embodiment of the present invention will be explained with reference to the drawings.

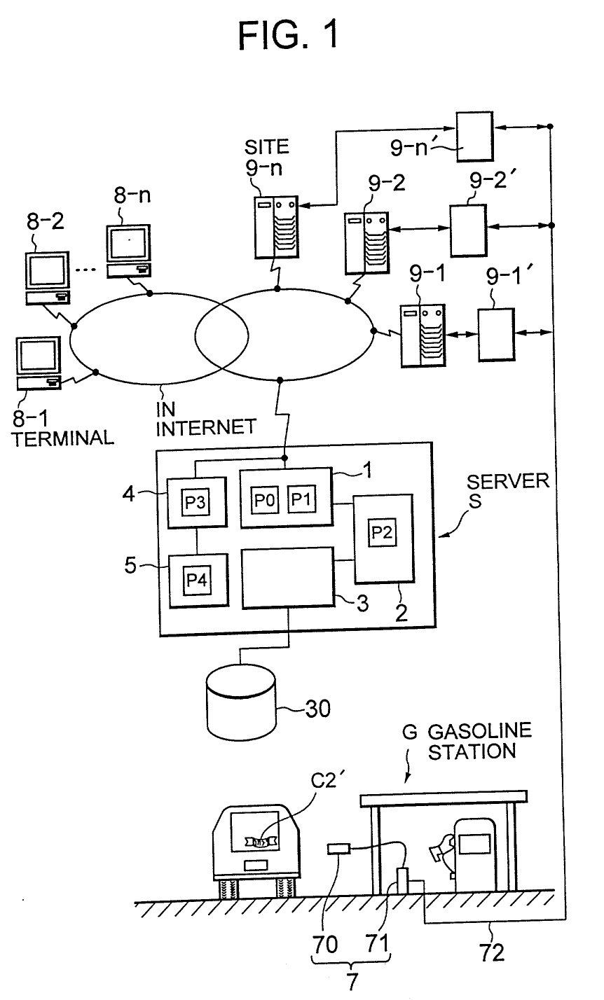

FIG. 1 is a block diagram of a sticker distribution system according to an embodiment of the present invention.

As shown in FIG. 1, the sticker distribution system of the present embodiment is comprised of a server S provided with a prize information display unit 1, a sticker information display unit 2, an image extraction unit 3, a user registration unit 4, and user preference information transmitting unit 5 and connected to the Internet IN and display confirmation devices 7 for reading the later-mentioned identification information 6 installed at gasoline stations G at different locations.

The prize information display unit 1 is for displaying first pages P1 carrying names of sponsors of desired products, conditions for display of the stickers, and prize information showing prizes on browsers of terminals 8-1 to 8-n connected to the Internet IN.

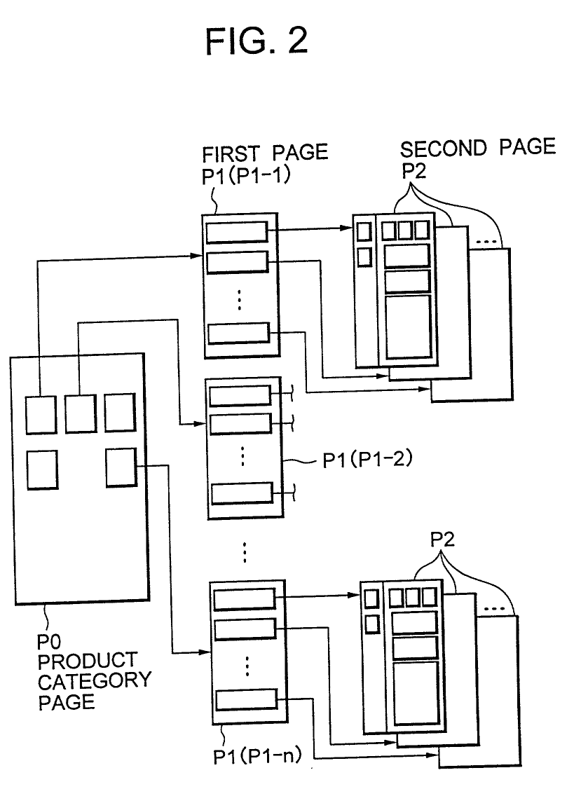

Specifically, as shown in FIG. 2, first pages P1 (P1-1 to p1-n) are linked with a product category page P0. The product category page P0 is displayed on the browsers of the terminals 8-1 to 8-n by the function of a WWW server provided at the server S, then first pages P1 selected at the product category page P0 are displayed on the browsers of the terminals.

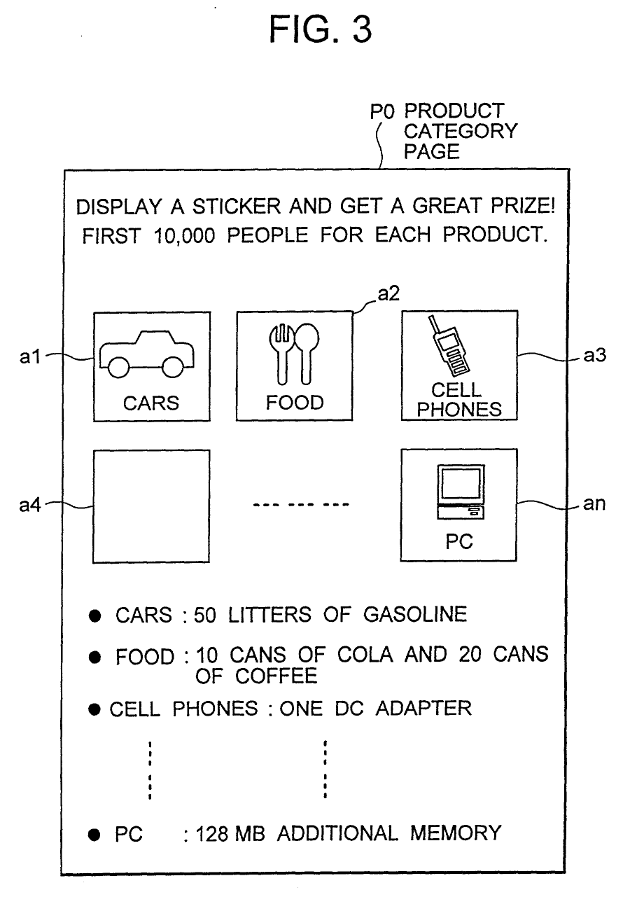

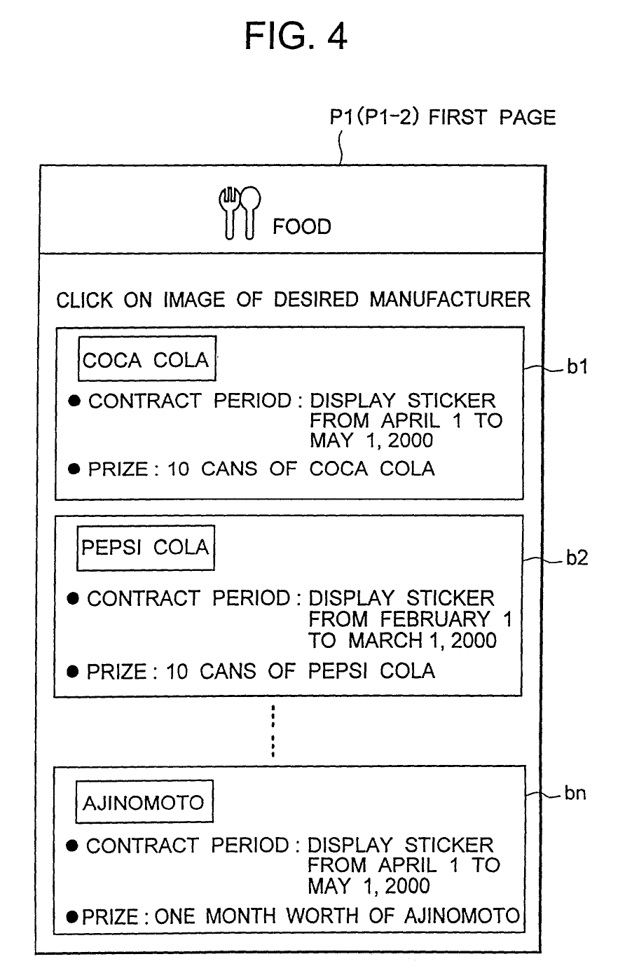

That is, as shown in FIG. 3, the product category page P0 carries images a1 showing the product categories “CARS”, “FOOD”, CELL PHONES”, . . . “PCs” together with a leader promoting the fact that various types of prizes can be obtained by displaying the stickers. The images, as shown in FIG. 2, are linked with first pages P1-1 to P1-n related to the products of the images. Due to this, for example, when a user of one of the terminals 8-1 to 8-n clicks on the image a2 “FOOD” on the product category page P0, for example, as shown in FIG. 4, the first page P1-2 carrying the prize information b1 to bn is displayed. The prize information b1 to bn include the names of sponsors manufacturing and selling the products “FOOD” , the conditions for display of the stickers which the sponsors impose on the user, and the prizes. Further, the prize information b1 to bn are linked with the later mentioned second pages P2 as shown in FIG. 2.

The sticker information display unit 2 shown in FIG. 1 is provided after the prize information display unit 1 and displays the second pages P2 linked with the prize information b1 to bn of the first page P1 on the browsers of the terminals 8-1 to 8-n.

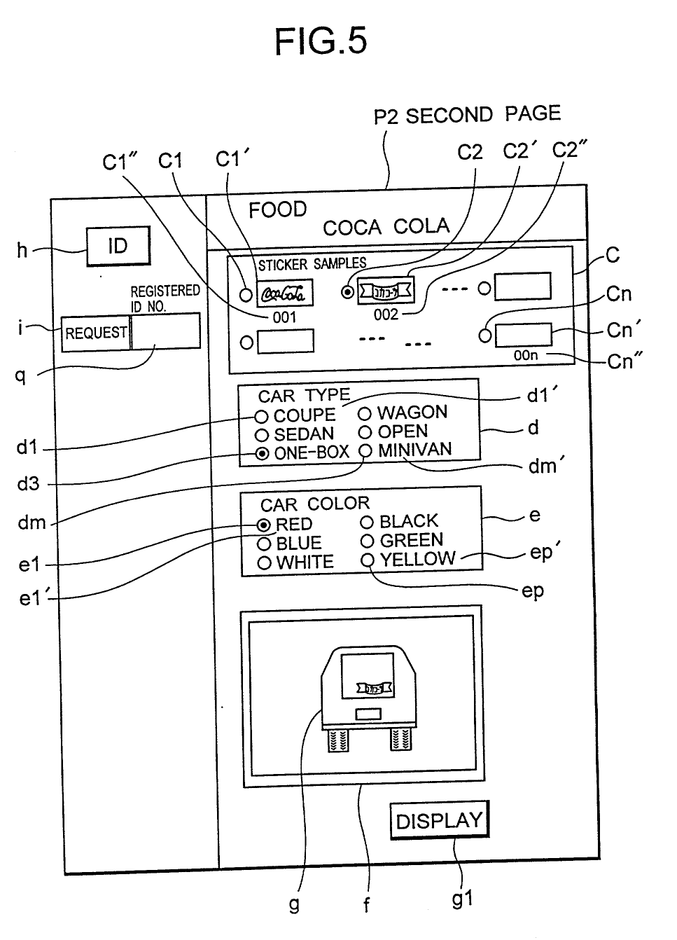

FIG. 5 is a plan view of a second page P2.

As shown in FIG. 5, the second page P2 includes a sample window c for selecting a sample of a sticker of different sponsors, a type window d for selecting a type of car, a color window e for selecting a color of car, and a display window f for displaying a rear image of a car in the state with the sticker sample selected by the user attached to the rear. Specifically, the sample window c is provided with a plurality of sticker samples c1′ to cn′ with check boxes c1 to cn (n being a whole number), while the sticker samples c1′ to cn′ are provided with sticker numbers c1 ″ to cn″. Further, the type window d is provided with type names d1′ to dm with check boxes d1 to dm (m being a whole number). Further, the color window e is provided with color names e1′ to ep′ with check boxes e1 to ep (p being a whole number). Due to this, by clicking on check boxes, it is possible to select the desired sticker sample and car type and color. Further, the display window f is designed to display the rear image of the car by the function of the image extraction unit 3.

In FIG. 1, the image extraction unit 3 is a unit for reading out a car rear image comprised of the sticker sample, car type, and car color selected by the second page P2 from the database 30 and displaying it in the display window f of the second page P2.

That is, there are n×m×p variations of the car rear view image g shown in in FIG. 5 comprised of the combination of n number of types of sticker samples listed in the sample window c of the second page P2, the m number of car types listed in the type window d, and the p types of colors listed in the color window e, so n×m×p types of images are stored in the database 30. When a user of one of the terminals 8-1 to 8-n checks one of the check boxes c1 to cn, one of the check boxes d1 to dm, and one of the check boxes e1 to ep in the sample window c, the type window d, and the color window e of the second page P2 displayed on the browser and then clicks on the DISPLAY button g1, the image extraction unit 3 reads the car rear image g satisfying all of the information from the database 30 and displays it in the display window f.

Further, the second page P2 is provided with an ID button h and a SEND button i.

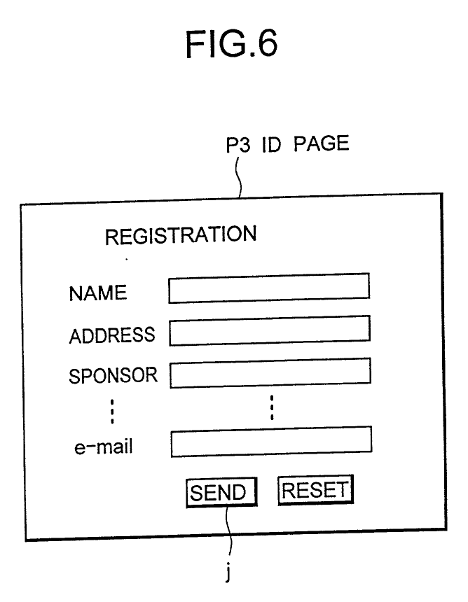

The ID button h is a button for entering the user information of the users of the terminals 8-1 to 8-n and is linked with the ID page P3 shown in FIG. 6. The IP page P3 is provided with a text box for entering the name and address of a user and other user information. By clicking on the SEND button j, the user information entered in the text box is sent to the user registration unit 4 shown in FIG. 1.

The user registration unit 4 shown in FIG. 1 has the function of registering the received user information plus an ID number, stores the information in the database 30, and sends the ID number to the terminals 8-1 to 8-n of the users.

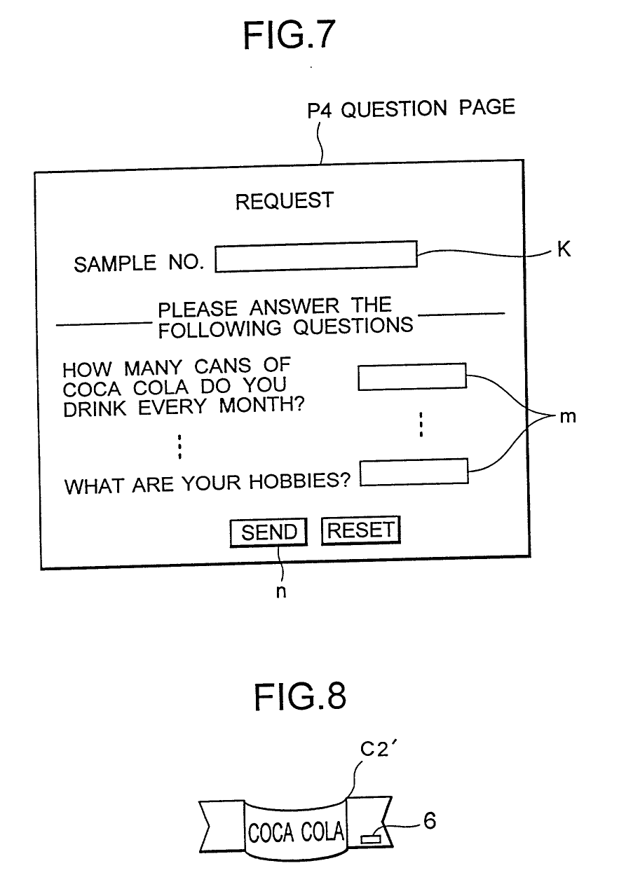

On the other hand, the REQUEST button i shown in FIG. 5 is a button to be clicked when a user requests a sticker decided on based on the car rear image g displayed in the display window f and is linked with the question page P4 shown in FIG. 7. The question page P4 is provided with a text box k for entering the sample no. (c1″ to cn″) of the sticker selected from the sticker sample c1′ to cn listed in the sample window c of the second page P2, text boxes m for inputting responses to questions from the sponsor, etc. By clicking on the SEND button n, the user preference information entered in the text boxes k and m is sent to the user preference information transmitting unit 5 shown in FIG. 1. Further, the text box q shown in FIG. 5 is provided for a user already having an ID number. By inputting the user ID number in the text box q, clicking on the REQUEST button i, and clicking on the SEND button of the question page P4, the information is sent to the user preference information transmitting unit 5.

The user preference information transmitting unit 5 shown in FIG. 1 has the function of storing the information comprised of the received user preference information plus the ID number of the user in the database 30 and sending it to the sites 9-1 to 9-n of the sponsors.

Note that bar codes or other identification information 6, as shown in FIG. 8, are provided on the stickers sent from the sponsors 9-1′ to 9-n of the sites 9-1 to 9-n or the owner of the server S to the users.

The display confirmation device 7 shown in FIG. 1 is provided with a reader 70 and a transceiver 71. The reader 70 is a device for reading the identification information 6. The transceiver 71 is a device for sending the read identification information 6 through a dedicated communications line 72 to whichever of the sponsors 9-1′ to 9-n provided the sticker. The display confirmation device 7 is installed at gasoline stations G at different points of a predetermined region.

Next, the operation of the sticker distribution system of this embodiment will be explained. Note that the operation is specifically realized by working the sticker distribution method of the second aspect of the present invention.

In FIG. 1, when the user of one of the terminals 8-1 to 8-n accesses the site of the server S, the product category page P0 shown in FIG. 3 is displayed on the browser of the terminal by the WWW server function of the server S.

Further, when the user clicks on the image a of for example “FOOD”, since the image is linked with the first page P1-2, the first page P1-2 shown in FIG. 4 is displayed on the browser of the terminal by the function of the prize information display unit 1.

The user views the prize information b1 to bn of the sponsors listed on the page, considers the prizes and conditions, and selects the desired sponsor. For example, when interested in the sponsor “Coca Cola”, the user clicks on the prize information b1.

Since the “Coca Cola” prize information b1 is linked with the second page P2, the second page P2 shown in FIG. 5 is displayed on the browser of the terminal by the function of the sticker information display unit 2.

The user can judge which sticker matches with the car he owns on the second page P2. For example, when the car is a “one-box” type and the color is “red”, as shown in FIG. 5, he checks the check box d3 of the type window d and checks the check box e1 of the color window e, then successively checks the check boxes c1 to cn of the sticker samples c1′ to cn′ of the sample window c. Each time, he clicks on the DISPLAY button g1, whereby, thanks to the function of the image extraction unit 3, the car rear image g of the checked sticker sample c1′ (to cn′) attached to the rear image of a “one-box”, “red” colored car is displayed in the display window f.

Each time the display button g1 is clicked on, the car rear view image g displayed on the display window f is viewed. When the preferred sticker sample c1′ (to cn′) is determined, it is possible to request the sticker be sent.

At this time, a user applying for the first time, that is, a user not previously given an ID number, can click on the ID button h. Due to this, the ID page P3 shown in FIG. 6 is displayed. The user enters his name and address and other user information in the text boxes, then clicks on the SEND button j to send the user information to the user registration unit 4 shown in FIG. 1. Due to the function of the user registration unit 4, the ID number is added to the user information for registration (user registration step), that information is stored in the database 30, the ID number is sent to the terminal (8-1 to 8-n) of the user, and the user obtains an ID number. At the same time, the owner of the server S can determine information unique to the user and the number of registered users. Note that a user already having an ID number may enter his ID number in the text box q, then click on the REQUEST button i.

When clicking on the REQUEST button i, the question page P4 shown in FIG. 7 is displayed.

Therefore, the user can enter the sample no. c1″ (to cn″) of the sticker sample c1′ (to cn′) of interest into the text box k of the question page P4. For example, when the user selects the sticker sample c2′, the sample no. c2″, that is, “002”, is entered. If the SEND button n is clicked on after the responses to the questions from the sponsor are entered in the text boxes m, the user preference information entered into the text boxes k and m are sent to the user preference information transmitting unit 5 shown in FIG. 1.

Due to this, due to the function of the user preference information transmitting unit 5, the information comprised of the user preference information plus the ID number of the user is stored in the database 30 and is transmitted to the site (9-1 to 9-n) of the sponsor.

Due to this, the sponsor “Coca Cola” can predict that one of its stickers will be selected and that its sticker will be attached to the car of a user and realize an advertising function and can obtain user preference information relating to its products.

The sticker requested by a user is sent from the owner of the server S or the sponsor (9-1′ to 9-n′) to the user by a predetermined means. The user obtains the sticker and attaches it to the rear of his car. He confirms the state of the sticker attached to his car in the display window f of the second page P2, so when the sticker is actually attached to the rear of the car, it becomes the state as envisioned by the user. In this state, when driving the car, the driver and passengers of cars driving behind it will look at the sticker. Unlike a seal attached to the entire car, the sticker is attached to the rear of the car, so many persons would desire to obtain the sticker.

The attachment of the sticker to the rear of the car by the user, however, is the minimum condition for realizing the advertising function of the sticker, so it is necessary for the sponsor to confirm that fact.

Therefore, when the sponsor sends a sticker to a user, it may instruct the user to take procedures for confirming the attachment of the sticker at a designated gasoline station G to enable the sponsor to confirm that the user has actually attached the sticker to the rear of the car. Specifically, the user drives into a designated gas station shown in FIG. 1 and attaches the sticker to the rear of the car. The attendant of the gasoline station G runs the reader 70 over the identification information 6 of the sticker to read the identification information 6. The read identification information 6 is sent from the transceiver 71 through the communications line 72 to the sticker providing sponsor 9-2′. Due to this, the sponsor 9-2′ can confirm that the sticker corresponding to the sticker sample c2′ has actually been attached to the rear of the user's car. Therefore, even in the case where there are a large number of users acquiring stickers scattered through a broad region, the sticker providing sponsor 9-2′ can reliably determine that the sticker has actually been attached to the car.

While the invention has been described with reference to specific embodiment chosen for purpose of illustration, it should be apparent that numerous modifications could be made thereto by those skilled in the art without departing from the basic concept and scope of the invention.

For example, in the above embodiment, as shown in FIG. 4, a “CONTRACT PERIOD” was used as a condition for attachment of a sticker imposed on the user by the sponsor given in the prize information (b1 to bn) of the first page P1, but the distance driven with the sticker attached may also be used as the condition. Further, the prize need not be a product and may also be cash.

Further, in the above embodiment, the ID button h was provided in only the second page P2, but of course it is also possible to provide it in the product category page P0 or the first page P1 or other page.

Further, in the above embodiment, the sample no. (cl″ to cn″) of the sticker selected at the second page P2 was entered by the user in the text box k of the question page P4, but it is of course possible to click on an image of one of the sticker samples c1′ to cn′ by using a computer graphic interface program or the like so that the sample no. is automatically entered in the text box k and the image automatically attached to a predetermined location of the question page P4.

Further, in the above embodiment, the display confirmation devices 7 for reading the identification information 6 were installed in the gasoline stands G of different regions, but the invention is not limited to this. These may be installed at convenience stores etc. as well.

Further, in the above embodiment, the identification information 6 read by the readers 70 were transmitted through dedicated communication lines 72 to the sponsors 9-1′ to 9-n′ but the owner of the server S can also confirm the display by having the sponsors 9-1′ to 9-n′ send the identification information 6 to the sites 9-1 to 9-n. Further, it is possible to not provide the dedicated lines and to send the information through the Internet N to the sites 9-1 to 9-n of the sponsors 9-1′ to 9-n′ and the server S.

Summarizing the effects of the invention, according to the present invention, it is possible to confirm the state of a sticker attached to a car on a browser, so there is the advantageous effect that the actual state of attachment becomes that as imagined by the prospective displayer. Further, since the sticker is attached to the rear of the car, the drivers and passengers of cars driving behind it will look at the sticker, so the advertising effect of the sponsor is far more improved that the case of attachment of the sticker to the side of the car. Further, since the sticker differs from a seal attached to the entire car and the sticker is attached to the rear of the car, there are the effects of a large number of persons wishing to acquire the sticker and of a sufficient advertising effect being obtained.

Further, by providing identification information on the stickers, identifying the identification information at different points in a predetermined region, and sending that identification information to the sponsor providing the stickers through dedicated communication lines, the sponsor providing the stickers can confirm that prospective sticker displayers scattered over a broad region are actually attaching the stickers to their cars.

The present disclosure relates to subject matter contained in Japanese Patent Application No. 2000-305391, filed on Oct. 4, 2000, the disclosure of which is expressly incorporated herein by reference in its entirety.

I claim:

1. A sticker distribution system comprising:
a prize information display unit for displaying, on a browser of a terminal connected to the Internet, a first page carrying the names of sponsors of products, conditions for displaying stickers, and prize information showing prizes;
a sticker information display unit for displaying, on a browser of a terminal, a second page linked with prize information of a sponsor designated at a terminal, having a sticker sample window, a car type window, and a car color window, and displaying the rear image of a car in the state with a sample of a predetermined sticker attached;
an image extraction unit for reading from a database storing a plurality of car rear images showing samples of stickers attached to the rears of various types of cars of various colors a car rear image comprising the sample of a sticker selected in the sticker sample window, the type of the car selected in the car type window, and the color of the car selected in the car color window on the display unit; a user registration unit for registering user information identifying the user of a terminal; and
a user preference information transmitting unit for transmitting to the sponsor the sticker sample selected by the user of a terminal and user preference information regarding a product of a sponsor providing the sticker sample.

2. A sticker distribution system as set forth in claim 1, further providing identification information on a sticker in accordance with the selected sticker sample and providing different points in a predetermined region with display confirmation devices for identifying the identification information of the sticker and sending the identification information to the sponsor providing the sticker through a predetermined communications line.

3. A sticker distribution method comprising the steps of:
displaying, on a browser of a terminal connected to the Internet, a first page carrying the names of sponsors of products, conditions for displaying stickers, and prize information showing prizes;
displaying, on a browser of a terminal, a second page linked with prize information of a sponsor designated at a terminal, having a sticker sample window, a car type window, and a car color window, and displaying the rear image of a car in the state with a sample of a predetermined sticker attached;
extracting a car rear image comprising a rear image of of a car of a selected type of and selected color to which a selected sticker sample has been attached based on the sticker sample selected in the sticker sample window, the type of the car selected in the car type window, and the color of the car selected in the car color window and displaying it on the display unit;
registering user information identifying the user of the terminal;
transmitting the sticker sample selected by the user of the terminal and user preference information regarding the products of the sponsor providing the sticker sample to the sponsor;
providing identification information on a sticker in accordance with the selected sticker sample; and
identifying the identification information of the sticker at different points in a predetermined region and sending the identification information to the sponsor providing the sticker through a predetermined communications line.
